(19) United States
(12) Patent Application Publication
(10) Pub. No.: US 2018/0101799 A1
(43) Pub. Date: Apr. 12, 2018

(54) Closed Loop Business Administration Process

(71) Applicant: Jonathan Matthew Ray, Gilbert, AZ (US)

(72) Inventor: Jonathan Matthew Ray, Gilbert, AZ (US)

(21) Appl. No.: 15/289,168

(22) Filed: Oct. 8, 2016

(51) Int. Cl. G06Q 10/06; G06Q 10/10

(52) U.S. Cl. CPC G06Q 10/06311; G06Q 10/1053; G06Q 10/06398

(57) ABSTRACT

The problem of business reliance on expert judgement is solved through charge number coding with an added code line for the complexity or work difficulty (a ‘complexity factor’). A complete charge number code provides the means to automate many business functions that are traditionally conducted through expert judgment. The primary purpose of the charge number code with Complexity Factor is to automate or assist in cost and schedule estimating. The use of a Complexity Factor in stored performance information provides the additional means for automating many Program Management, Business Development Management, and Personnel Management functions. These functions include personnel projections, scheduling, and assessment, program performance reporting, and Work Breakdown Structure (WBS) creation. The complete charge number code also provides the means for data navigation through the System and an integrated Business and Program Information Systems.

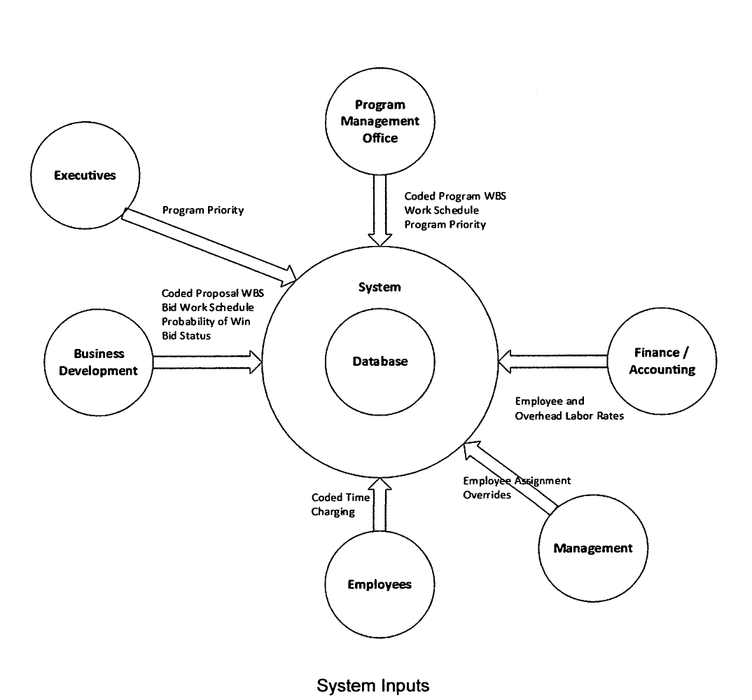

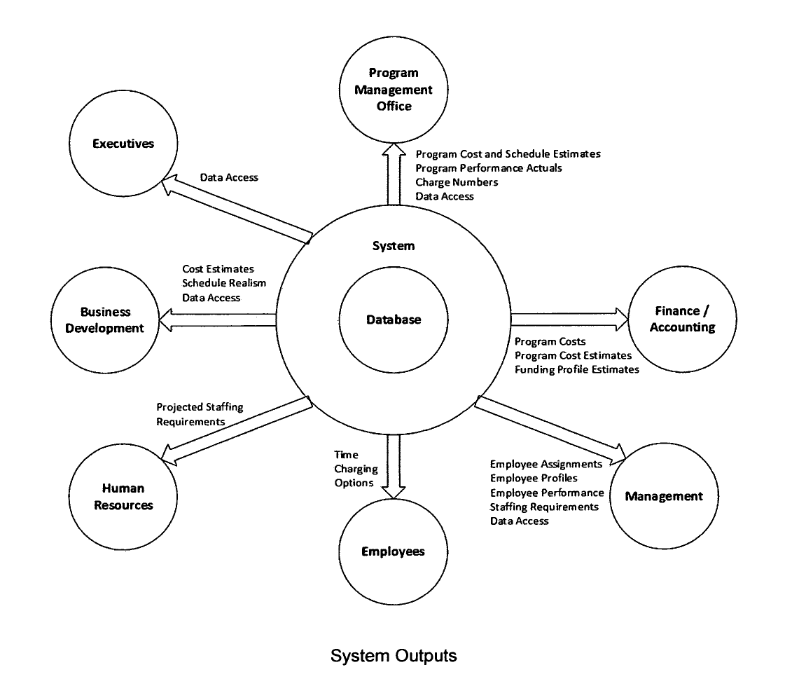

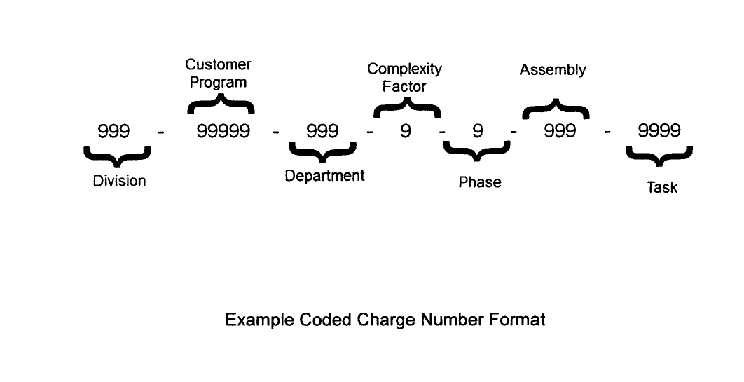

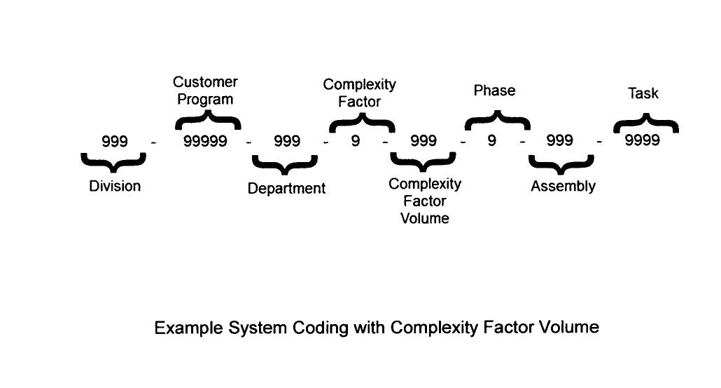

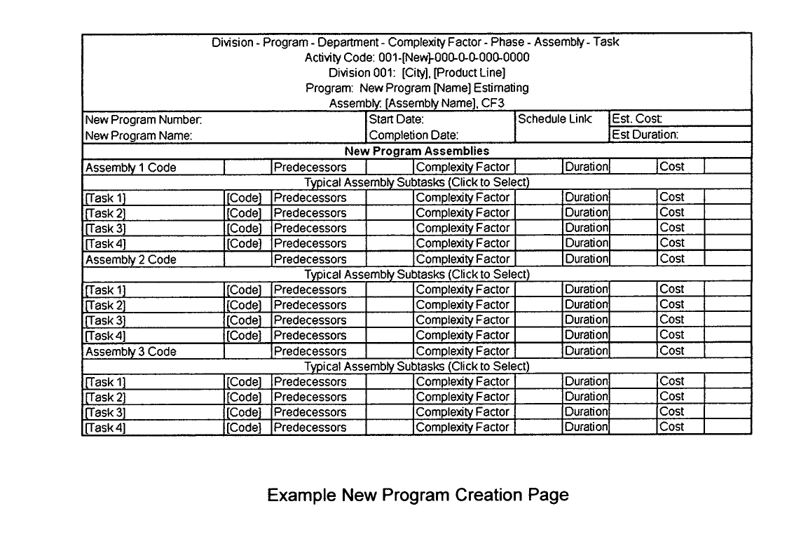

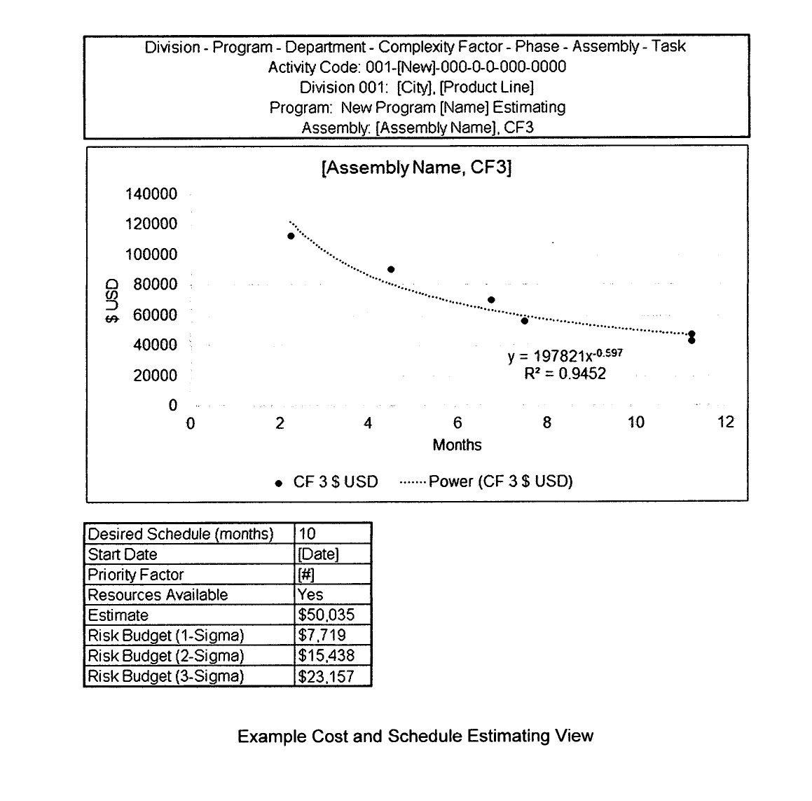

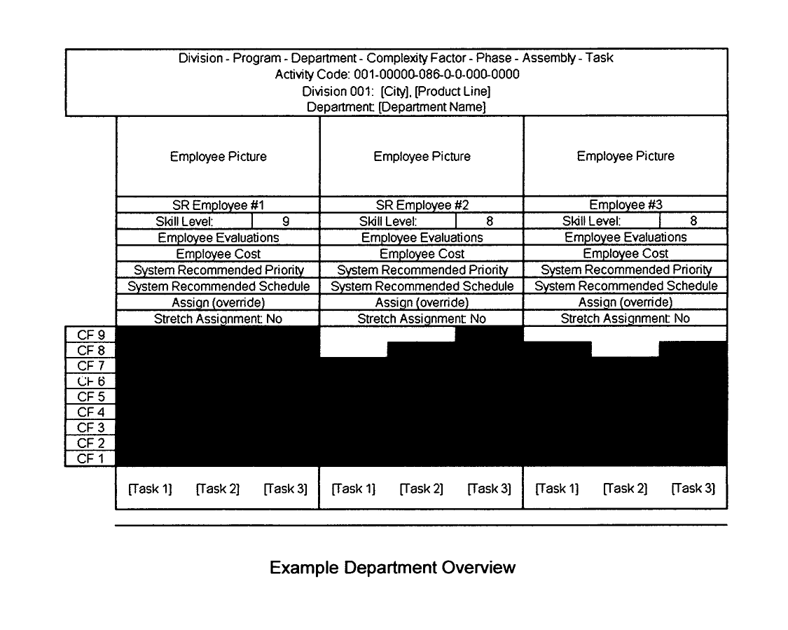

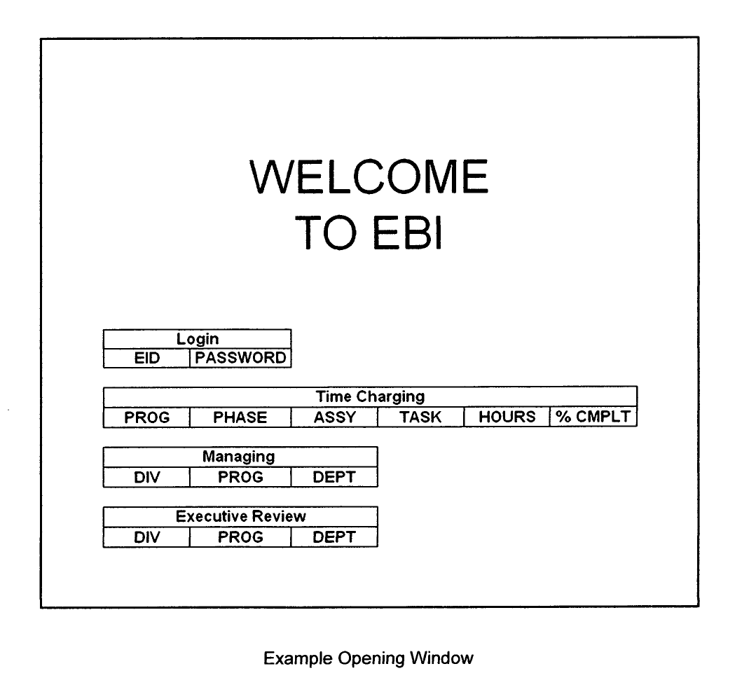

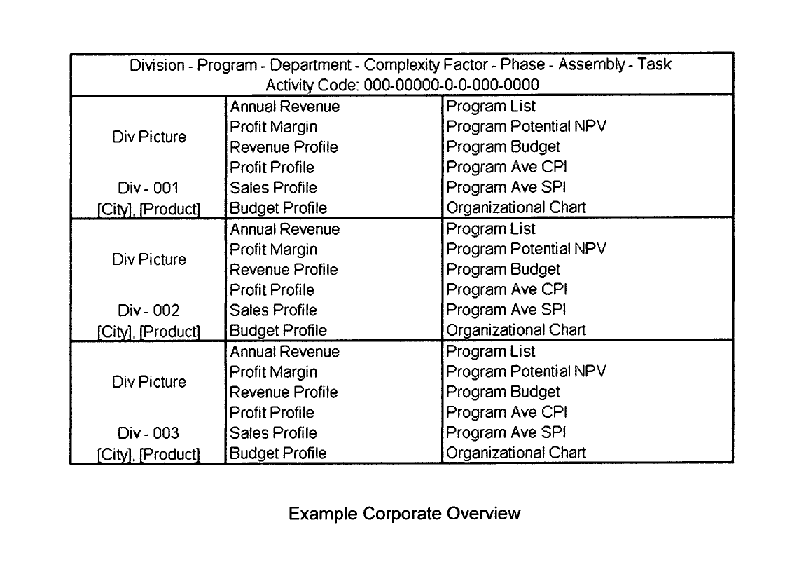

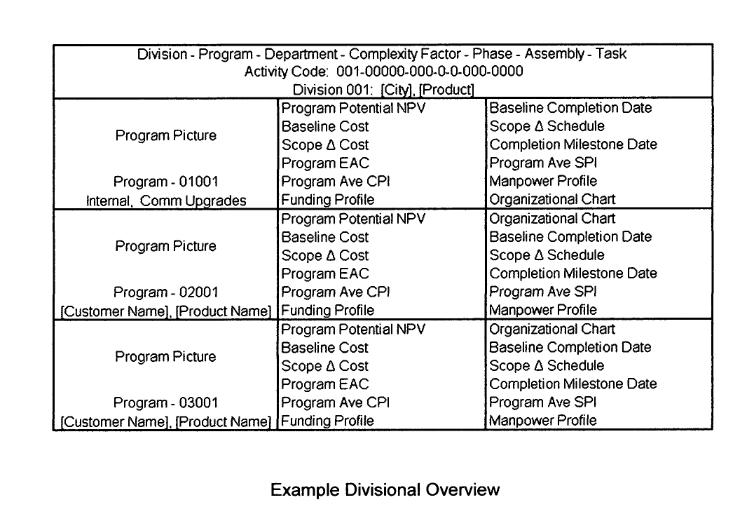

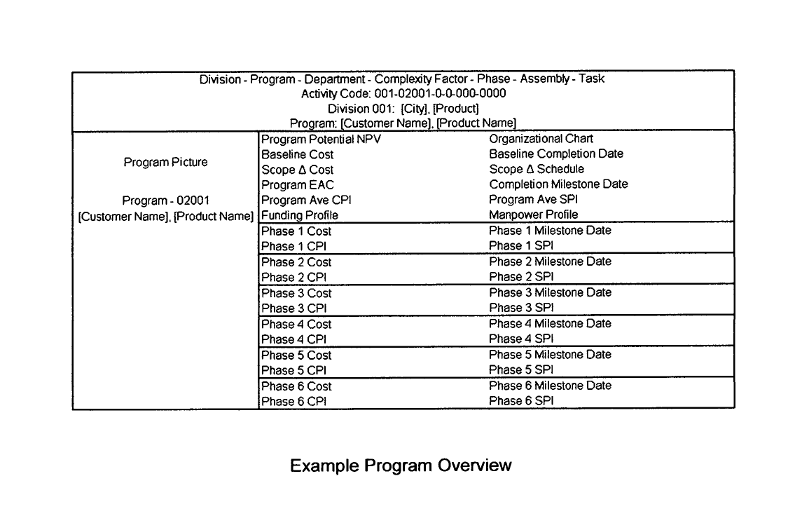

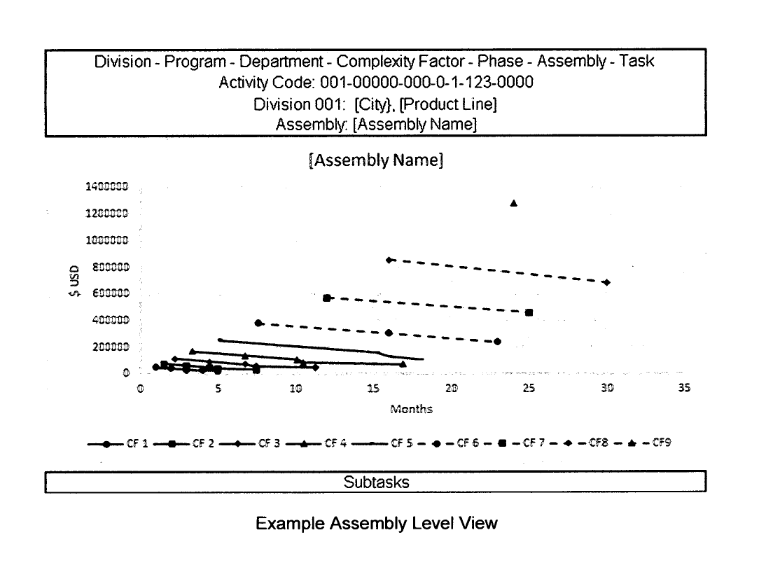

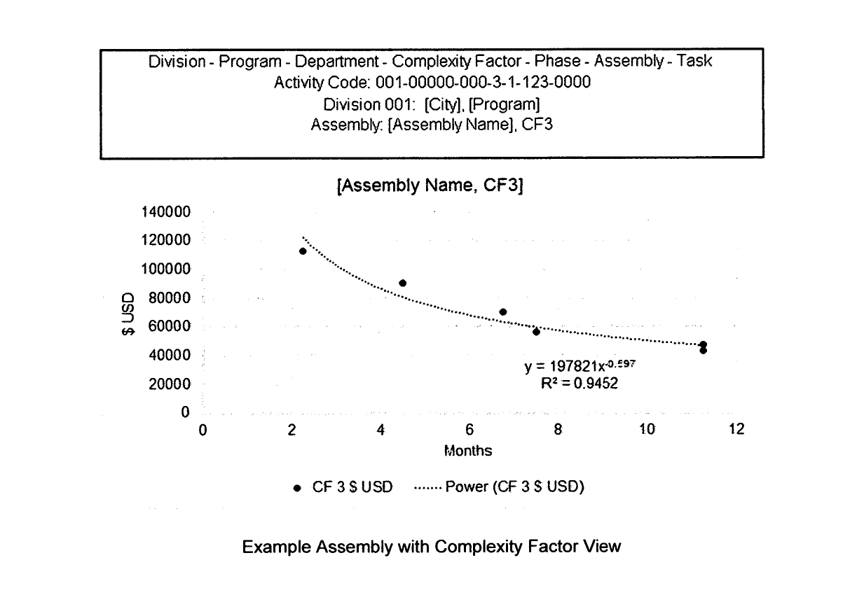

### CROSS-REFERENCE TO RELATED APPLICATIONS

Not Applicable

### FEDERALLY SPONSORED RESEARCH

Not Applicable

### REFERENCE TO MATERIAL SUBMITTED SEPARATELY

Not Applicable

### BACKGROUND OF THE INVENTION

The inventors realized that essentially all proposal labor and schedule estimates are based in Expert Judgement. Experts are required even when using relevant data on completed similar program work to create estimates since the complexity of the work or uniqueness of each problem requires an expert and lengthy comparison to the proposed work in order to generate an estimate. Program Managers and Business Development Managers face this reliance on Expert Judgement. Worse yet, the objective of Program Management is to complete programs with Schedule Performance and Cost Performance Indexes (SPI and CPI) of exactly 1. Finishing ahead of schedule or below budget should be positive for the Program Manager, but in actuality it means that the Program Manager did a poor job of estimating and locked up company funding that could've been used elsewhere. So how can a company determine a great Program Manager from an average one if it can't be determined if the estimates were poor or the execution great? This problem appears throughout business as estimating, performance assessment, and even personnel assignments and assessments are based on Expert Judgement. So the question the inventors answered is how can we break free of Expert Judgement and generate actual values or numerical ranges through automation?

### BRIEF SUMMARY OF THE INVENTION

The problem of business reliance on expert judgement is solved through charge number coding with an added code line for the complexity or work difficulty (a ‘complexity factor’). A complete charge number code provides the means to automate many business functions that are traditionally conducted through expert judgment. The primary purpose of the charge number code with Complexity Factor is to automate or assist in cost and schedule estimating. The use of a Complexity Factor in stored performance information provides the additional means for automating many Program Management, Business Development Management, and Personnel Management functions. These functions include personnel projections, scheduling, and assessment, program performance reporting, and Work Breakdown Structure (WBS) creation. The complete charge number code also provides the means for data navigation through the System and an integrated Business and Program Information Systems.

### BRIEF DESCRIPTION OF THE DRAWINGS

The schematic drawings, 1/13 and 2/13, show basic inputs and outputs of a coded charge number System with Complexity Factor. The System can perform most business functions with basic coded Work Breakdown Structure (WBS) and priority inputs from Business Development and/or Program Management offices, labor rates, and employee coded charging. When new programs or new business bids are created the System takes in the WBS with Complexity Factor coding and outputs projected estimates for both schedule and cost. Once the new business or program is entered the System tentatively assigns/schedules resources/employees to the work tasks and outputs projected labor needs. Once the new business or program is initiated the System opens the charge numbers, assigns the scheduled personnel, and outputs labor and cost profiles, as well as labor needs. As the program progresses the System outputs real-time performance information. The System also provides immediate data access to executive and management teams, as well as the ability for executives to reestablish program relative priorities.

Drawing 3/13 is an example format for a coded charge number includes the basics associated with any corporation such as the corporate Division, Program being charged, and Personnel Department, but completes the charge number with a Complexity Factor, Phase of the program, and Assembly and Task level information. Drawing 4/13 is an example System Coding with an additional Complexity Factor Volume.

Drawings 5/13 through 13/13 depict example system interface views. The system interface and navigational approach are discussed in the Detailed Description of the Invention paragraphs [0016] through [0026].

### DETAILED DESCRIPTION OF THE INVENTION

The problem of business reliance on expert judgement is solved through charge number coding with an added code line for the complexity or work difficulty (a ‘complexity factor’). A complete charge number code, as shown in Drawing 3/13, provides the means to automate many business functions that are traditionally conducted through expert judgment. The primary purpose of the charge number code with Complexity Factor is to automate or assist in cost and schedule estimating. The use of a Complexity Factor in stored performance information provides the additional means for automating many Program Management, Business Development Management, and Personnel Management functions. The complete charge number code also provides the means for data navigation and an integrated Business and Program Information Systems.

Drawing 3/13 shows an example or recommended charge number format. This format includes the basics associated with any corporation such as the corporate Division, Program, and personnel Department, but completes the charge number with a Complexity Factor, program Phase, as well as Assembly and Task level information. Although this charge number format may appear complicated it can easily be completed by any employee charging and any employee working on estimates. The charging employee is not required to select the Division or Department when charging since they are associated with the employee's identification number or login information, which is stored in the database. The Program being charged is required for employees charging in most current business operations. The Complexity Factor is not assigned by or selected by the employee filling out their time sheet charging, but rather through the estimating process, which is described in detail in following paragraphs. Phases are simple and well known as Phases and Phase gates (often called Stages and Stage Gates) are required in standard program management. A typical Phase delineation is (1) Research and Development, (2) Bid and Proposal, (3) Design, (4) Development, (5) Qualification, and (6) Production. The cost associated with completing the same task on the same assembly can vary wildly in different phases therefore this information is important to record. The assembly or program Project level is simple to identify and beneficial in monitoring active program costs and estimating new program costs. The quantity of available tasks, at the Task level, can be greatly limited in a dropdown menu for the employees because tasks are tethered to the Division, Department, and Assembly. The tasks available for an employee to select in charging is also limited by the WBS inputs during estimating, as described in the following paragraphs. The charge number format is therefore simple for the employee since every employee should know where they work, for who they work, on what they're working, and what task they are performing before charging to a program.

Complexity Factors are framed in a way that makes them easily identifiable while capturing various levels of work difficulty. An example complexity factor table is shown in Table 1. This table demonstrates typical complexities associated with engineering firms that reuse, modify, or create new designs for similar, modified, or new applications. This form of Complexity Factor identification simplifies cost estimating since an estimator is only required to identify if the new program will perform work that has been previously conducted, as well as if the previous solutions will require modifications for the new program work. This Complexity Factor structure captures various levels of difficulty, as reusing designs requires less work than developing new designs and applying known designs to similar applications requires less work than applying new designs on new applications. This example format is therefore easily distinguishable while capturing various levels of work difficulty.

TABLE 1

| CF # | Complexity Factor Description |
|---|---|
| 1 | Reused Design on Similar Application |
| 2 | Reused Design on Modified Application |
| 3 | Reused Design on New Application |
| 4 | Modified Design on Similar Application |
| 5 | Modified Design on Modified Application |
| 6 | Modified Design on New Application |
| 7 | New Design on Similar Application |
| 8 | New Design on Modified Application |
| 9 | New Design on New Application |

Another way of viewing charge number coding would use multiple measures of complexity through additional dash lines. For example, in software development there is a complexity factor associated with developing new code versus updating existing code, as well as porting to a different language or baseline, modifying to a change in hardware or operating system. There is also a complexity associated with the volume of code such as the number of lines or blocks. In cases such as this more than one parametric measure may be required and the estimation codes within the System need to reflect this. An example code for multiple parametric measures is shown in Drawing 4/13.

The work process, hereby referred to as ‘the System’, is closed looped. The System stores the hours and cost associated with completing the program's tasks as existing programmatic work is conducted. The recorded task performance data provides new program creation information including Tasks associated with Assembly or High Level work for Work Breakdown Structure (WBS) creation. Once Complexity Factors are added to a New Program WBS the System provides cost and schedule estimates. When the new program is initiated, the System provides the charge number set for the new program to charge against thereby looping the process.

The System is able to generate estimates for proposal or projects through the stored, coded programmatic data without the use of expert judgement. A Program number is assigned to the proposal or project. A Work Breakdown Structure is then used to identify the assemblies and optional tasks required to complete the proposed or project work. Each WBS item is assigned a Complexity Factor and the WBS is then input into the System with the same coded charge number format as used by employees when charging. Team members involved in the estimating process are not required to provide expert judgement in the estimation process as they are only required to identify the Complexity Factor of a given task. The System takes the coded WBS and provides a cost and schedule estimate for each item based on stored data and available resources. The assembly or task level costs are then rolled up into a total programmatic cost. This process can be iterative, as a desire to shorten schedule requires the System to bias its comparative analysis to the shorter schedule and presumably higher cost data points within the data set. It is worth noting that Initial System implementation can use historical information that is coded for the System or it can be implemented on a moving forward basis in which the initial WBSs and estimates would require expert judgement for tasks not yet recorded in the System.

New Program creation page, example shown in Drawing 5/13, provides the means for the Program or Business Development offices to create new programs in the System. The System assigns the next available Program number. The creator then inputs the assemblies associated with the new program. The System retrieves tasks associated with the assemblies and the creator simply selects or adds tasks to build a Work Breakdown Structure (WBS). The creator selects complexity factors at the assembly or task levels and the System provides the cost and schedule estimates for the new program based on historical information. This estimating can be as simple as taking an average and deviation when several data points for the same task at the same Complexity Factor and schedule duration are available. When data points for the same task at the same complexity factor are not available, the System can estimate the cost through the application of regression analysis the same task at various complexity factors. The System outputs can be overridden by clicking into cost or schedule outputs and entering an estimating page, which is shown in Drawing 6/13. This view demonstrates how valuable the System is in creating and estimating new programs. The System knows previously charged tasks under each assembly, therefore knows the recommended subtasks. The System also knows the costs and schedule to complete each task based on complexity factor, therefore the System removes the need for expert judgement in estimating.

Drawing 6/13 shows an example Cost and Scheduling Estimating View. This view shows the power of the overall System, as it has both historical data and schedule availability readily available. The System can estimate costs based on the desired schedule with the Complexity Factor, while confirming availability of resources based on Program priority and flagging if additional resources will be required to complete the work on schedule. If estimates aren't available for new or initial work than the estimate would need to be provided by an expert.

The System's ability goes beyond estimating and into Personnel Management. The System stores data on the employee's identification number along with the task worked when the employee charges a program. This information allows the System to identify employee's capabilities on particular tasks. The system provides estimates on cost and schedule to complete tasks, so it can identify employees that over or underperform its projections. This is used in personnel assessments along with colleague assessments, such as 360 degree evaluations. The System also has information on the complexity of tasks that each employee has completed. With information on the employee's performance and complexity capabilities, the System assigns the proper personnel to complete upcoming tasks. With information on upcoming tasks, and assigned employees, the System also identifies shortfalls or excess in labor. It outputs the shortfalls to Human Resources and/or Personnel Management. The System also identifies the level of capability that is required to complete the coming work. This information is directly used for both hiring or layoff determinations, as it provides both the employee levels and skills required to complete projected work. Additionally, the System creates and/or has access to personnel assignments therefore can provide the employee with a limited set of charge numbers to which the employee is assigned for program charging purposes. By providing the limited set of charge numbers the System mitigates the risk of improper or inaccurate charging.

The Department view, example shown in Drawing 7/13, contains all key information on the Department's personnel. The System can establish employee capability based on previous tasks completed and the tasks complexity factor. The Department view also provides management with easy access to employee's schedules as assigned by the System for override when necessary or to assign an employee a higher level task, ‘Stretch Assignment’ as a reward for success or based on new capabilities such as those acquired through training or continuing education.

Charge number coding also provides a means for quick data access and information system navigation. Security settings associated with employee identification numbers and passwords limit access to applicable data retrieval and managerial control functions. The charge number code is then used to pull up the desired information or management window.

The System provides a means of rapid data entry or navigation. As shown in example Drawing 8/13, data entry such as time charging and data navigation can be handled in the same window using charge number coding. Drop down options on each item make data entry and navigation simple. Selecting a Division and a Program of ‘New’ for example would take a Program Office or Business Development manager to a new Program creation and cost estimating function, while Executive data navigation entries of ‘all’ or a coded charge number entry of ‘0’, for example, open corporate, divisional, or department overviews.

The Corporate view contains all key information on the corporation's divisions. An example view and key information set is shown in Drawing 9/13. A single click on any listed item can bring up complete data, while a click on the Divisional picture navigates to the Divisional overview.

The Divisional view contains all desired key information on the Division's Programs. An example view and key information set is shown in Drawing 10/13. A single click on any listed item can bring up complete data, while a click on the Program Picture navigates to the Program overview.

The Program view contains all key information on the Program's current and historical performance. An example view and key information set is shown in shown in Drawing 11/13, A single click on any listed item can bring up complete data. The progression from Corporate overview to Program view with just three selections demonstrates the power of the System's navigation capability. This ability is aided by being tethered to the charge number coding in that each link simply navigates to the System page for that coded entry.

The Assembly view, example shown in Drawing 12/13, contains all key information on any assembly. This information includes the cost and schedules required to complete work at the assembly level, as well as a list of typical subtasks that must be completed in order to finish the assembly level work. Drawing 12/13 shows data trending. In general, the cost of completing work increases with complexity factor and decreases with longer schedules.

The Assembly view with Complexity Factor, example shown in Drawing 13/13, shows the variability in the cost of completing assembly level work, as well as the impact of schedule on the same Assembly type with the same level of complexity. This view is a subset of the Assembly level view with the addition of a complexity factor. The view can also be reached by simply clicking on a complexity factor in the Assembly view window.

1. The use of charge number coding with a Complexity Factor provides the basis for a complete business management architectural System including, but not limited to, automating cost and schedule estimating activities, identifying hiring needs or excess labor, and evaluating employee performance.

2. The use of charge number coding with a complexity factor to assist in Work Breakdown Structure (WBS) creation and automated estimating.

3. The System provides the means to automate many Program Management functions such as charge number management, schedule, finance, and labor loading, employee assignment delegation, task level start, completion, and performance reporting, employee charging, employee demand, and cost accounting.

4. The System uses charge number coding as a navigational tool for business data retrieval and navigation.
